(19) United States
(12) Patent Application Publication
(10) Pub. No.: US 2025/0016335 A1
(43) Pub. Date: Jan. 9, 2025

(54) METHOD, APPARATUS, AND MEDIUM FOR VIDEO PROCESSING

(71) Applicants: Beijing Bytedance Network Technology Co., Ltd., Beijing (CN); Bytedance Inc., Los Angeles, CA (US)

(72) Inventors: Jizheng XU, Los Angeles, CA (US); Na ZHANG, Beijing (CN)

(21) Appl. No.: 18/893,479

(22) Filed: Sep. 23, 2024

Related U.S. Application Data
(63) Continuation of application No. PCT/CN2023/083110, filed on Mar. 22, 2023.

(30) Foreign Application Priority Data
Mar. 23, 2022 (WO) PCT/CN2022/082529

(51) Int. Cl. H04N 19/176; H04N 19/136; H04N 19/196

(52) U.S. Cl. CPC H04N 19/176; H04N 19/136; H04N 19/196

(57) ABSTRACT

Embodiments of the present disclosure provide a solution for video processing. A method for video processing is proposed. The method comprises: determining, for a conversion between a video unit of a video and a bitstream of the video, a block vector of the video unit based on a base block vector candidate and a parameter related to a block vector difference; and performing the conversion based on the block vector.

### CROSS-REFERENCE TO RELATED APPLICATIONS

This application is a continuation of International Application No. PCT/CN2023/083110, filed on Mar. 22, 2023, which claims the benefit of Chinese Application No. PCT/CN2022/082529 filed on Mar. 23, 2022. The entire contents of these applications are hereby incorporated by reference in their entireties.

### FIELDS

Embodiments of the present disclosure relates generally to video processing techniques, and more particularly, to block vector coding.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a video unit of a video and a bitstream of the video, a block vector of the video unit based on a base block vector candidate and a parameter related to a block vector difference; and performing the conversion based on the block vector. In this way, coding efficiency of block vector coding can be improved.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: determining a block vector of a video unit of the video based on a base block vector candidate and a parameter related to a block vector difference; and generating the bitstream based on the block vector.

In a fifth aspect, a method for storing a bitstream of a video is proposed. The method comprises: determining a block vector of a video unit of the video based on a base block vector candidate and a parameter related to a block vector difference; generating the bitstream based on the block vector; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 shows an intra template matching search area used;

FIG. 5 shows MMVD search point;

FIG. 6 shows an example to derive BVDx and BVDy from BVDI, indicated as a single integer;

FIG. 7a illustrates an example to derive BVDy from BVDI when BVPx=0;

FIG. 7b illustrates an example to derive BVDx from BVDI when BVPy=0;

FIG. 8 illustrates a flowchart of a method for video processing in accordance with embodiments of the present disclosure; and

FIG. 9 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

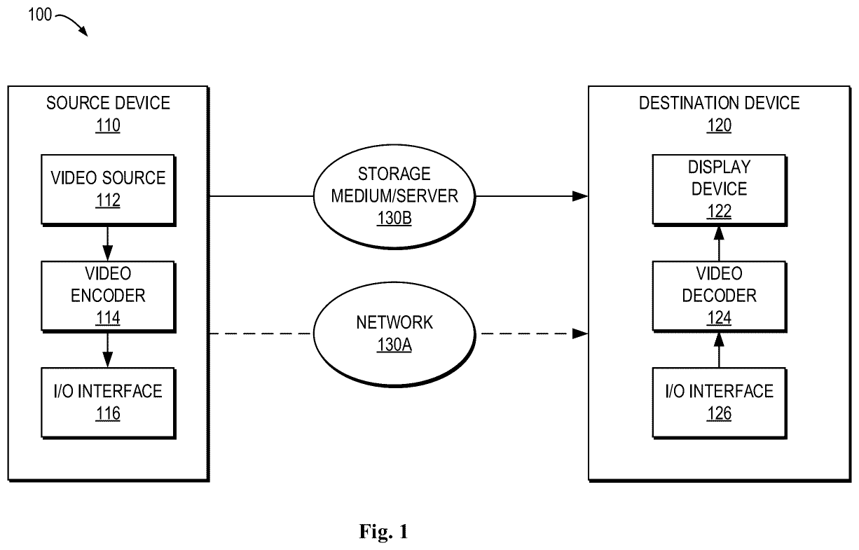

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

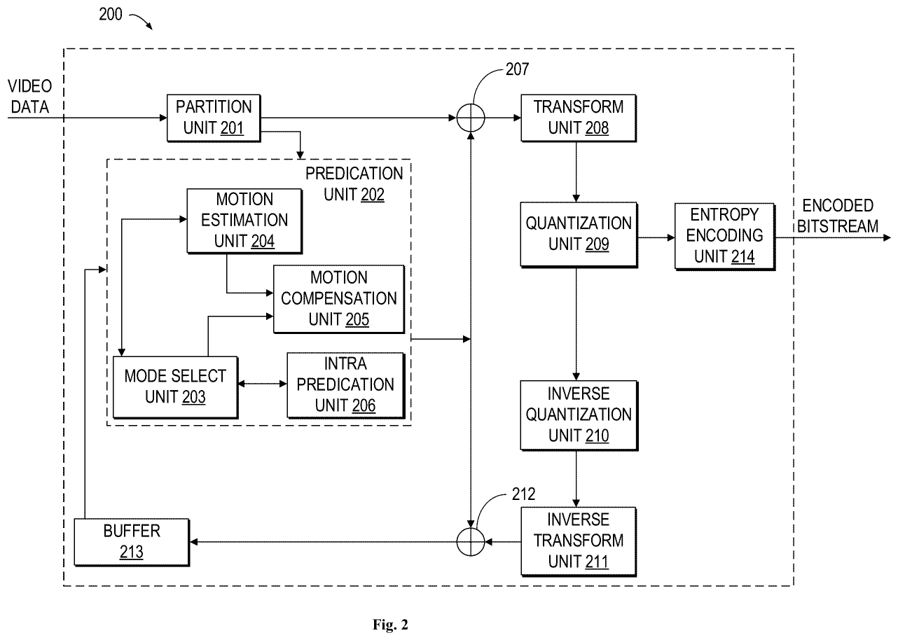

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

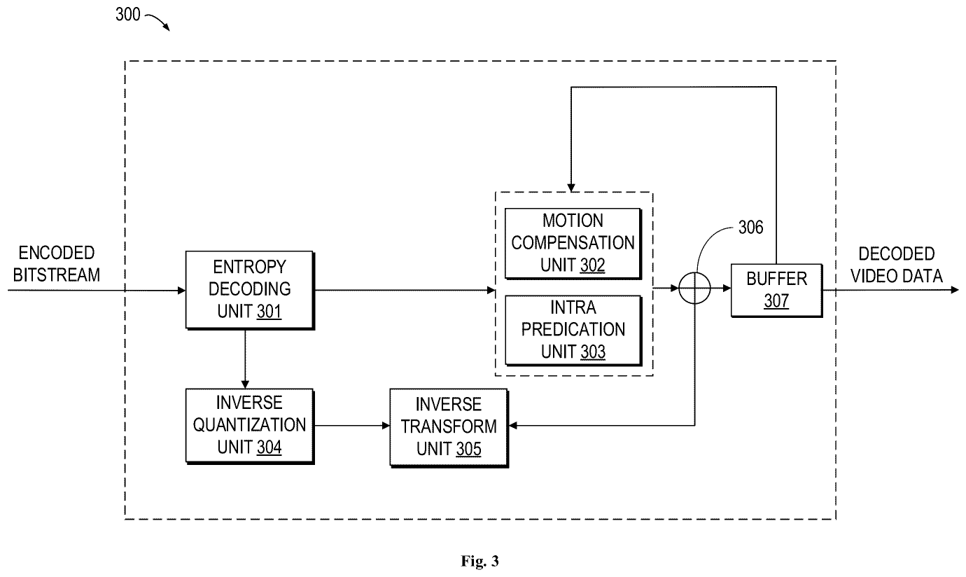

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This present disclosure is related to video coding technologies. Specifically, it is related to intra block copy in video coding. It may be applied to the standard under development or planning, e.g., next generation video coding standards beyond the Versatile Video Coding standard (ITU-T Recommendation ITU-T H.266: Versatile video coding, https://www.itu.int/rec/T-REC-H.266). It may be also applicable to future video coding standards or video codec.

### 2. Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC), H.265/HEVC and the latest H.266/Versatile Video Coding (VVC) standards. Since H.261, the video coding standards are based on the hybrid video coding structure wherein temporal prediction plus transform coding are utilized. To explore the future video coding technologies beyond VVC, Joint Video Exploration Team (JVET) started development of the Enhanced Compression Model in April 2021. Since then, many new methods have been adopted by JVET and put into the reference software. The latest software can be found at https://vcgit.hhi.fraunhofer.de/ecm/ECM/-/tags/ECM-4.0.

### 2.1 Virtual Pipeline Data Unit

Virtual pipeline data units (VPDUs) are defined as non-overlapping M×M-luma(L)/N×N-chroma(C) units in a picture. In hardware decoders, successive VPDUs are processed by multiple pipeline stages at the same time; different stages process different VPDUs simultaneously. The VPDU size is roughly proportional to the buffer size in most pipeline stages, so it is very important to keep the VPDU size small. In HEVC hardware decoders, the VPDU size is set to maximum transform block (TB) size. In VVC, the VPDU size is increased to 64×64-luma/32×32-chroma for 4:2:0 format.

### 2.2 Intra Block Copy in VVC

To support Intra Block Copy (IBC) in VVC, a virtual buffer concept is used for reference buffer management. As in JVET-T2001-v2 document, given the CTU size, i.e., CtbSizeY, the buffer width in luma sample is defined as:

IbcBufWidthY=256*128/CtbSizeY.

The cossponding chroma IBC buffer is defined as:

IbcBufWidthC=IbcBufWidthY/SubWidthC,

where SubWidthC depends on chroma format, which is defined in the following table.

TABLE 1
SubWidthC and SubHeightC values derived
from sps_chroma_format_idc

| sps_chroma_format_idc | Chroma format | SubWidthC | SubHeightC |
|---|---|---|---|
| 0 | Monochrome | 1 | 1 |
| 1 | 4:2:0 | 2 | 2 |
| 2 | 4:2:2 | 2 | 1 |
| 3 | 4:4:4 | 1 | 1 |

The height of the buffer in luma sample is CtbSizeY.

In VVC, a VPDU concept is applied to enable parallel decoding among different VPDUs within a CTU to increase the decoding throughput. Its size can be derived from CTU size, as in the following table.

TABLE 2
VPDU size derived from CTU size in VVC

| CTU size | VPDU size |
|---|---|
| 128 × 128 | 64 × 64 |
| 64 × 64 | 64 × 64 |
| 32 × 32 | 32 × 32 |

VVC only supports CTU size being 32×32, 64×64 and 128×128. At the beginning of decoding a CTU row in a slice, the luma IBC buffer is reset to be −1. Before decoding a new VPDU, the luma buffer corresponding to that VPDU is also reset to be −1. After finishing decoding a VPDU's data prior to loop filtering, the corresponding buffer samples are updated to the VPDU data that have been just reconstructed.

After a CU has been reconstructed, the reconstructed samples before loop-filtering are stored in the IBC buffer as follows (as described in the text of JVET-T2001-v2):

The following assignments are made for i=0 . . . nCurrSw−1, j=0 . . . nCurrSh−1:

$$x V b = ( xCurr + i ) \% ( ( cIdx == 0 ) ? IbcBufWidthY : IbcBufWidthC ) \qquad ( 1197 )$$

$$yVb = ( yCurr + j ) \% ( ( cIdx == 0 ) ? CtbSizeY : ( CtbSizeY / subHeightC ) ) \qquad ( 1198 )$$

$$IbcVirBuf [ cIdx ] [ xVb ] [ y V b ] = recSamples [ xCurr + i ] [ yCurr + j ] . \qquad ( 1199 )$$

If a CU uses IBC mode, its prediction is formed as follows:

When cIdx is equal to 0, for x=xCb . . . xCb+cbWidth−1 and y=yCb . . . yCb+cbHeight−1, the following applies:

$$x V b = ( x + ( b v [ 0 ] >> 4 ) ) \& ( IbcBufWidthY - 1 ) \qquad ( 1096 )$$

$$yVb = ( y + ( b v [ 1 ] >> 4 ) ) \& ( CtbSizeY - 1 ) \qquad ( 1097 )$$

$$predSamples [ x - x C b ] [ y - y C b ] = I b c V i r B u f [ 0 ] [ x V b ] [ y Vb ] . \qquad ( 1098 )$$

When cIdx is not equal to 0, for

x=xCb/SubWidthC . . . xCb/SubWidthC+cbWidth/SubWidthC−1 and

y=yCb/SubHeightC . . . yCb/SubHeightC+cbHeight/SubHeightC−1, the following applies:

$$xVb = ( x + ( bv [ 0 ] >> ( 3 + SubWidthC ) ) ) \& ( IbcBufWidthC - 1 ) \qquad ( 1099 )$$

$$yVb = ( y + ( bv [ 1 ] >> ( 3 + SubHeightC ) ) ) \& ( ( CtbSizeY / subHeightC ) - 1 ) \qquad ( 1100 )$$

$$predSamples [ x - ( xCb / SubWidthC ) ] [ y - ( yCb / SubHeightC ) ] = I b c V i r Buf [ cIdx ] [ x V b ] [ y Vb ] . \qquad ( 1101 )$$

### 2.3 Enhanced Compression Model

After finishing the 1^{st} version of VVC, JVET started to develop a test model to explore further coding efficiency improvement over VVC. The test model is named Enhanced Compression Model. Many new coding tools, e.g. intra temporal matching, dependent quantization with 8-states, are integrated into the VVC test model to improve the coding efficiency. For descriptions of new added tools, one may refer to “A. Browne, J. Chen, Y. Ye, S. Kim, “Algorithm description for Versatile Video Coding and Test Model 15 (VTM 15),” JVET-X2002”.

It is noted that in ECM, the CTU size can be extended to 256×256. However, the IBC buffer with the extended CTU size and corresponding processing are undefined.

### 2.4 Intra Template Matching

Intra template matching prediction (Intra TMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

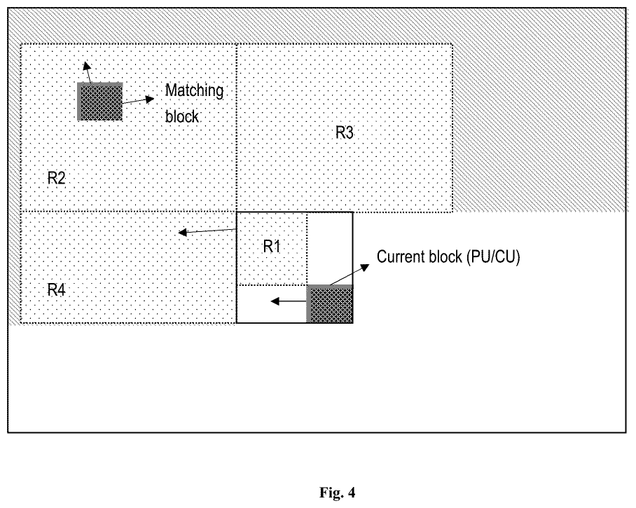

The prediction signal is generated by matching the L-shaped causal neighbor of the current block with another block in a predefined search area in FIG. 4 consisting of:
R1: current CTU,
R2: top-left CTUs,
R3: above CTUs,
R4: left CTUs.

SAD is used as a cost function.

Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:

SearchRange_w=a*BlkW

SearchRange_h=a*BlkH

where ‘a’ is a constant that controls the gain/complexity trade-off. In practice, ‘a’ is equal to 5.

The Intra template matching tool is enabled for CUs with size less than or equal to 64 in width and height. This maximum CU size for Intra template matching is configurable.

The Intra template matching prediction mode is signaled at CU level through a dedicated flag.

### 2.5 Merge Mode with MVD (MMVD)

In addition to merge mode, where the implicitly derived motion information is directly used for prediction samples generation of the current CU, the merge mode with motion vector differences (MMVD) is introduced in VVC. A MMVD flag is signalled right after sending a reqular merge flag to specify whether MMVD mode is used for a CU.

In MMVD, after a merge candidate is selected, it is further refined by the signalled MVDs information. The further information includes a merge candidate flag, an index to specify motion magnitude, and an index for indication of motion direction. In MMVD mode, one for the first two candidates in the merge list is selected to be used as MV basis. The mmvd candidate flag is signalled to specify which one is used between the first and second merge candidates.

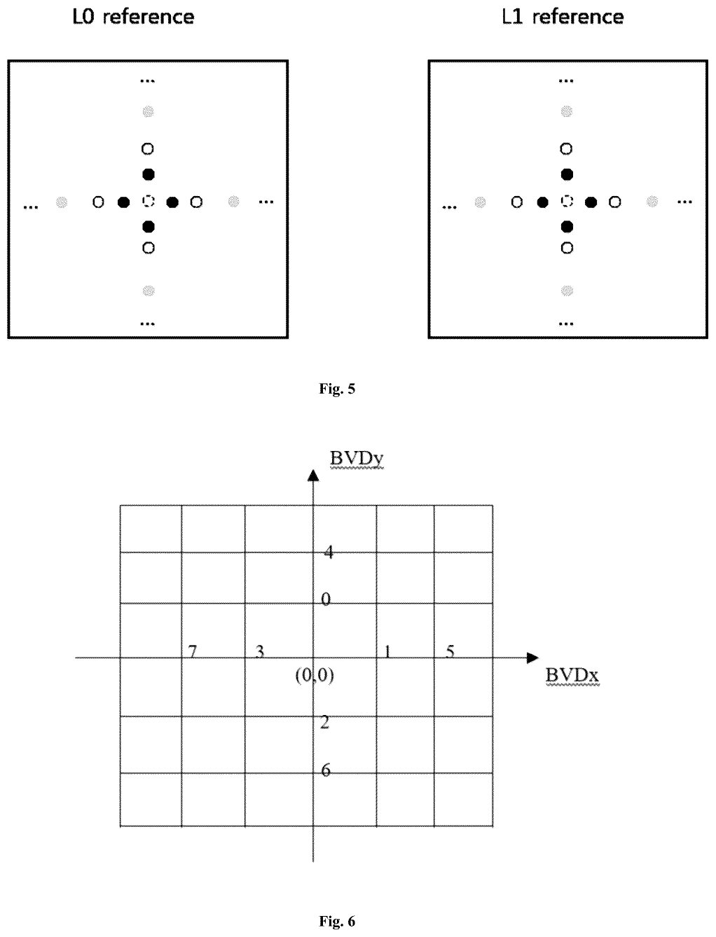

Distance index specifies motion magnitude information and indicate the pre-defined offset from the starting point. As shown in FIG. 5, an offset is added to either horizontal component or vertical component of starting MV. The relation of distance index and pre-defined offset is specified in Table 3.

TABLE 3
The relation of distance index and pre-defined offset

| Distance IDX | 0 | 1 | 2 | 3 | 4 | 5 | 6 | 7 |
|---|---|---|---|---|---|---|---|---|
| Offset (in unit of | ¼ | ½ | 1 | 2 | 4 | 8 | 16 | 32 |
| luma sample) | | | | | | | | |

Direction index represents the direction of the MVD relative to the starting point. The direction index can represent of the four directions as shown in Table 4. It's noted that the meaning of MVD sign could be variant according to the information of starting MVs. When the starting MVs is an un-prediction MV or bi-prediction MVs with both lists point to the same side of the current picture (i.e. POCs of two references are both larger than the POC of the current picture, or are both smaller than the POC of the current picture), the sign in Table 4 specifies the sign of MV offset added to the starting MV. When the starting MVs is bi-prediction MVs with the two MVs point to the different sides of the current picture (i.e. the POC of one reference is larger than the POC of the current picture, and the POC of the other reference is smaller than the POC of the current picture), and the difference of POC in list 0 is greater than the one in list 1, the sign in Table 4 specifies the sign of MV offset added to the list0 MV component of starting MV and the sign for the list1 MV has opposite value. Otherwise, if the difference of POC in list 1 is greater than list 0, the sign in Table 4 specifies the sign of MV offset added to the list1 MV component of starting MV and the sign for the list0 MV has opposite value.

The MVD is scaled according to the difference of POCs in each direction. If the differences of POCs in both lists are the same, no scaling is needed. Otherwise, if the difference of POC in list 0 is larger than the one of list 1, the MVD for list 1 is scaled, by defining the POC difference of L0 as td and POC difference of L1 as tb. If the POC difference of L1 is greater than L0, the MVD for list 0 is scaled in the same way. If the starting MV is uni-predicted, the MVD is added to the available MV.

TABLE 4
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

The syntax elements for the direction index and distance index are mmvd_direction_idx and mmvd_distance_idx respectively. mmvd_direction_idx is binarized with fixed length binarization and mmvd_distance_idx is binarized with truncated rice binarization with cMax being 7 and cRiceParam being 0. The first bin of binarized mmvd_distance_idx is coded using CABAC with a specific context.

### 3. Potential Problems

There are many issues when applying MMVD on block vectors, for example, the characteristics of block vectors are much different from that of motion vectors, which leads to inefficient representation of block vectors. This document proposes multiple design points to improve the coding efficiency of block vector coding.

### 4. Detailed Solutions

To improve the coding efficiency for block vectors, methods as summarized below are disclosed. Embodiments should be considered as examples to explain the general concepts and should not be interpreted in a narrow way. Furthermore, these embodiments can be applied individually or combined in any manner.
1) A block vector (BVx, BVy) may be represented as function of a base candidate (BVPx, BVPy) and an index BVDI, i.e. (BVx, BVy)=f(BVPx, BVPy, BVDI).
   a. In one example, a base candidate (BVPx, BVPy) may be from a merge candidate, a spatial block vector candidate, a history block vector candidate, a pair-wise block vector candidate, a constant block vector candidate.
b. In one example, BVx=BVPx+fx(BVDI) and/or BVy=BVPy+fy(BVDI), where fx( ) and fy( ) denotes functions with BVDI as input.
   c. In one example, BVx=BVPx+fx(BVPx, BVPy, BVDI) and/or BVy=BVPy+fy(BVPx, BVPy, BVDI), where fx( ) and fy( ) denotes functions with BVPx, BVPy, BVDI as input.
2) A block vector (BVx, BVy) may be represented as function of abase candidate (BVPx, BVPy), a step index stepIdx and a direction index dirIdx, i.e. (BVx, BVy)=f(BVPx, BVPy, stepIdx, dirIdx).
   a. In one example, BVx=BVPx+fx(stepIdx, dirIdx) and/or BVy=BVPy+fy(stepIdx, dirIdx), where fx( ) and fy( ) denotes functions with stepIdx, dirIdx as input.
   b. In one example, BVx=BVPx+fx(BVPx, BVPy, stepIdx, dirIdx) and/or BVy=BVPy+fy(BVPx, BVPy, stepIdx, dirIdx), where fx( ) and fy( ) denotes functions with BVPx, BVPy, stepIdx, dirIdx as input.
3) A block vector (BVx, BVy) may be represented as a base candidate (BVPx, BVPy) added with a difference vector (BVDx, BVDy) that can be derived from an index BVDI.
   a. In one example, BVDx may be a function of BVDI.
   b. In one example, BVDy may be a function of BVDI.
   c. In one example, when BVPx is equal to 0, BVDx may be derived as 0.
   d. In one example, when BVPy is equal to 0, BVDy may be derived as 0.
   e. In one example, the function to derive BVDy may depend on whether BVPx is equal to 0 or not.
   f. In one example, the function to derive BVDx may depend on whether BVPy is equal to 0 or not.
   g. In one example, the function to derive BVDy may depend on whether BVPy is equal to 0 or not.
   h. In one example, the function to derive BVDx may depend on whether BVPx is equal to 0 or not.
4) A block vector (BVx, BVy) may be represented as a base candidate (BVPx, BVPy) added with a difference vector (BVDx, BVDy) that can be derived from a step index stepIdx and a direction index dirIdx.
   a. In one example, BVDx may be a function of stepIdx and dirIdx.
   b. In one example, BVDy may be a function of stepIdx and dirIdx.
   c. In one example, when BVPx is equal to 0, BVDx may be derived as 0.
   d. In one example, when BVPy is equal to 0, BVDy may be derived as 0.
   e. In one example, the function to derive BVDy may depend on whether BVPx is equal to 0 or not.
   f. In one example, the function to derive BVDx may depend on whether BVPy is equal to 0 or not.
   g. In one example, the function to derive BVDy may depend on whether BVPy is equal to 0 or not.
   h. In one example, the function to derive BVDx may depend on whether BVPx is equal to 0 or not.
5) BVDI or part of BVDI may be binarized with EGk binarization.
   a. In one example, BVDI>>1 may be binarized with EGk binarization.
   b. In one example, BVDI>>2 may be binarized with EGk binarization.
   c. In one example, BVDI>>k (e.g., k is a positive integer) may be binarized with EGk binarization.
6) stepIdx or part of stepIdx may be binarized with EGk binarization.
   a. In one example, stepIdx>>1 may be binarized with EGk binarization.
   b. In one example, stepIdx>>2 may be binarized with EGk binarization.
   c. In one example, stepIdx>>k (e.g., k is a positive integer) may be binarized with EGk binarization.
7) The last k (e.g., k is a positive integer) bit(s) of BVDI may be binarized with fixed length binarization.
   a. In one example, the last bit of BVDI may be binarized with fixed length binarization.
   b. In one example, the last 2 bits of BVDI may be binarized with fixed length binarization.
8) The last k (e.g., k is a positive integer) bit(s) of stepIdx may be binarized with fixed length binarization.
   a. In one example, the last bit of stepIdx may be binarized with fixed length binarization.
   b. In one example, the last 2 bits of stepIdx may be binarized with fixed length binarization.
9) BVDI may have a maximum value and/or a minimum value.
10) In one example, the step difference between two adjacent steps may have limitation.
   a. In one example, the step difference between two adjacent steps may be fixed.
      i. In one example, the step difference between two adjacent steps may be k (e.g., k=1).
      ii. In one example, the step difference between two adjacent steps may be k (e.g., k=2).
   b. In one example, the step difference between two adjacent steps may be adaptive.
   c. In one example, the step difference between two adjacent steps may be no more than k.
      i. In one example, k may be 4.
      ii. In one example, k may be 8.
      iii. In one example, k may be 16.
   d. In one example, the step difference between two adjacent steps may be adaptively set according to the step value.
      i. In one example, the step difference between two adjacent steps may be set to k1 if the larger step is ≤S1; the step difference between two adjacent steps may be set to k2 if the larger step is ≤S2 and >S1; the step difference between two adjacent steps may be set to k3 if the larger step is >S2. For example, k1=1, k2=2, k3=4, S1=64, S2=128.
11) Abs(BVDx)−1 and/or Abs(BVDy)−1 may be binarized with a EGk (k>1) binarization process.
   a. In one example, Abs(BVDx)−1 may be binarized with EG2/EG3/EG4/EG5 binarization process.
      i. In one example, the binarized code may be bypass coded.
   b. In one example, Abs(BVDy)−1 may be binarized with EG2/EG3/EG4/EG5 binarization process.
      i. In one example, the binarized code may be bypass coded.
   c. In one example, whether BVDx is equal to 0 may be context coded.
      i. In one example, the context may depend on BVPx and/or BVPy.
   d. In one example, whether BVDy is equal to 0 may be context coded.
      i. In one example, the context may depend on BVPx and/or BVPy.

### 5. Embodiments

### 5.1 Embodiment #1

A block vector (BVx, BVy) is derived by the following equations:

$$\begin{matrix}BVx = BVPx + BVDx \\ BVy = BVPy + BVDy\end{matrix}$$

where

$$B VDx = \{ \begin{matrix}0 , if BVDI is even \\ \frac{BVDI + 3}{4} , if ( BVDI + 3 ) is an integer multiple of 4 \\ - \frac{BVDI + 1}{4} , if ( BVDI + 1 ) is an integer multiple of 4\end{matrix}$$

$$BVDy = \{ \begin{matrix}0 , if BVDI is odd \\ \frac{BVDI + 4}{4} , if BVDI is an integer multiple of 4 \\ - \frac{BVDI + 2}{4} , if ( BVDI + 2 ) is an integer multiple of 4\end{matrix} .$$

It can be visualized in FIG. 6.

### 5.2 Embodiment #2

A block vector (BVx BVy) is obtained via the following equations:

$$\begin{matrix}BVx = BVPx + BVDx , \\ BVy = BVPy + BVDy .\end{matrix}$$

When BVPx is equal to 0, BVDx may be set to 0 and BVDy is derived as

$$BVDy = \{ \begin{matrix}\frac{BVDI + 2}{2} , if BVDI is even \\ - \frac{BVDI + 1}{2} , if BVDI is odd\end{matrix} .$$

When BVPy is equal to 0, BVDy may be set to 0 and BVDx is derived as

$$BVDx = \{ \begin{matrix}\frac{BVDI + 2}{2} , if BVDI is even \\ - \frac{BVDI + 1}{2} , if BVDI is odd\end{matrix} .$$

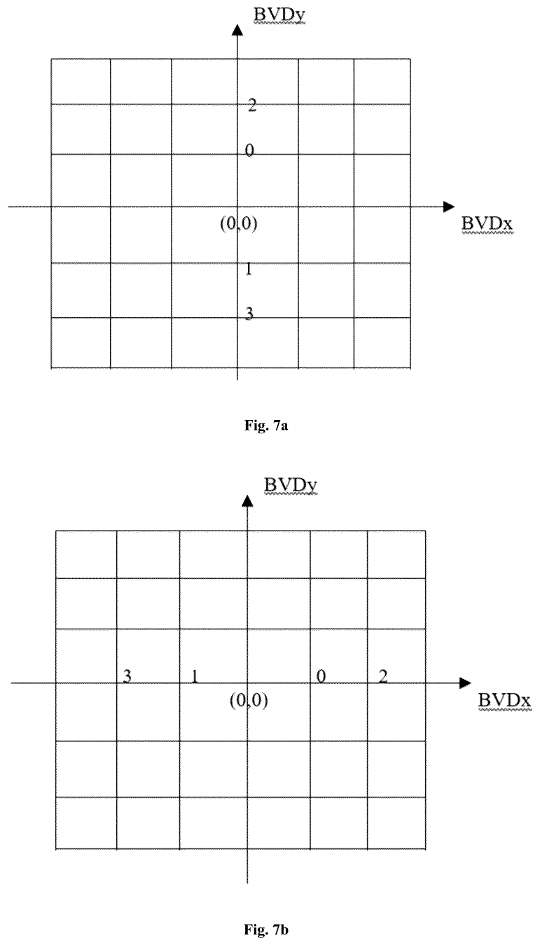

FIG. 7a illustrates an example to derive BVDy from BVDI when BVPx=0, and FIG. 7b illustrates an example to derive BVDx from BVDI when BVPy=0.

When both BVPx and BVPy are equal to 0, or both are not equal to 0, BVDx and BVDy may be derived following the method described in embodiment #1.

### 5.3 Embodiment #3

A examplar coding of (BVDx, BVDy) to reflect bullet 11.

| | Descriptor |
|---|---|
| bvd_coding( x0, y0 ) { | |
| abs_bvd_greater0_flag[ 0 ] | ae(v) |
| abs_bvd_greater0_flag[ 1 ] | ae(v) |
| if( abs_bvd_greater0_flag[ 0 ] ) { | |
| abs_bvd_minus1[ 0 ] | |
| bvd_sign_flag[ 0 ] | ae(v) |
| } | ae(v) |
| if( abs_bvd_greater0_flag[ 1 ] ) { | |
| abs_bvd_minus1[ 1 ] | |
| bvd_sign_flag[ 1 ] | |
| } | ae(v) |
| } | ae(v) |

abs_bvd_greater0_flag[x] are context coded. mvd_sign_flag and abs_bvd_minus1[x] are bypass coded.

As used herein, the term “video unit” ˜ or “video block” may be a sequence, a picture, a slice, a tile, a brick, a subpicture, a coding tree unit (CTU)/coding tree block (CTB), a CTU/CTB row, one or multiple coding units (CUs)/coding blocks (CBs), one ore multiple CTUs/CTBs, one or multiple Virtual Pipeline Data Unit (VPDU), a sub-region within a picture/slice/tile/brick. The term “image compression” ˜ may represent any variance of signal processing methods that compress or process the current input. The input images/videos include but not limited to the screen content and natural content.

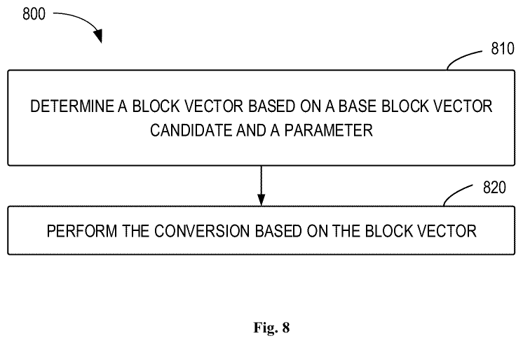

FIG. 8 illustrates a flowchart of a method 800 for video processing in accordance with embodiments of the present disclosure. The method 800 is implemented during a conversion between a video unit of a video and a bitstream of the video.

At block 810, for a conversion between a video unit of a video and a bitstream of the video, a block vector of the video unit is determined based on a base block vector candidate and a parameter related to a block vector difference. In other words, the block vector can be obtained by encoding/decoding the base block vector candidate and the parameter. In some embodiments, the base block vector candidate may include one of: a merge candidate, a spatial block vector candidate, a history block vector candidate, a pair-wise block vector candidate, or a constant block vector candidate.

At block 820, performing the conversion based on the block vector. In some embodiments, the conversion may include encoding the video unit into the bitstream. Alternatively, or in addition, the conversion may include decoding the video unit from the bitstream. In this way, the coding efficiency of the block vector coding can be improved.

In some embodiments, the parameter related to the block vector difference comprises a base vector difference index (BVDI). In this case, the block vector is represented based on the base block vector candidate and the BVDI. For example, the block vector is represented as: (BVx, BVy)=f(BVPx, BVPy, BVDI), where BVx is a first element of the block vector and BVy is a second element of the block vector, the base block vector candidate is represented as (BVPx, BVPy), BVPx is a first element of the base block vector candidate and BVPy is a second element of the base block vector candidate, and f(represents a function of the base block vector candidate and the BVDI. In other words, the block vector (BVx, BVy) may be represented as function of a base candidate (BVPx, BVPy) and an index BVDI, i.e. (BVx, BVy)=f(BVPx, BVPy, BVDI).

In some embodiments, BVx=BVPx+fx(BVDI), and/or BVy=BVPy+fy(BVDI), and where fx( ) and fy( ) denotes functions with BVDI as input. In some other embodiments, BVx=BVPx+fx(BVPx, BVPy, BVDI), and/or BVy=BVPy+fy(BVPx, BVPy, BVDI), and where fx( ) and fy( ) denotes functions with BVPx, BVPy, BVDI as input.

In some embodiments, the parameter related to the block vector difference comprises a difference vector that is derived from a BVDI. In this case, the block vector is represented as the base block vector candidate added with the difference vector. For example, the block vector is represented as (BVx, BVy), BVx is a first element of the block vector and BVy is a second element of the block vector, the base block vector candidate is represented as (BVPx, BVPy), BVPx is a first element of the base block vector candidate and BVPy is a second element of the base block vector candidate, and the difference vector is represented as (BVDx, BVDy), BVDx is the first element of the difference vector and BVDy is the second element of the difference vector. By way of example, a block vector (BVx, BVy) may be represented as function of a base candidate (BVPx, BVPy), a step index stepIdx and a direction index dirIdx, i.e. (BVx, BVy)=f(BVPx, BVPy, stepIdx, dirIdx).

In some embodiments, BVDx is a function of the BVDI. In some other embodiments, BVDy is a function of the BVDI.

In some embodiments, if BVPx is equal to 0, BVDx is derived as 0. In some other embodiments, if BVPy is equal to 0, BVDy is derived as 0.

In some embodiments, a function to derive BVDy depends on whether BVPx is equal to 0 or not. In some other embodiments, a function to derive BVDx depends on whether BVPy is equal to 0 or not.

In some embodiments, a function to derive BVDy depends on whether BVPy is equal to 0 or not. In some other embodiments, a function to derive BVDx depends on whether BVPx is equal to 0 or not.

In some embodiments, the BVDI may include a maximum value. Alternatively, or in addition, the BVDI may include a minimum value.

In some embodiments, the parameter related to the block vector difference comprises a step index and a direction index. In this case, the block vector is represented based on the base block vector candidate, the step index and the direction index.

In some embodiments, (BVx, BVy)=f(BVPx, BVPy, stepIdx, dirIdx), and (BVx, BVy) represents the block vector, (BVPx, BVPy) represents the base block vector candidate, f( ) represents the function of the base block vector candidate, the step index and the direction indes, stepIdx represents the step index, and dirIdx represents the direction index. For example, a block vector (BVx, BVy) may be represented as function of a base candidate (BVPx, BVPy), a step index stepIdx and a direction index dirIdx, i.e. (BVx, BVy)=f(BVPx, BVPy, stepIdx, dirIdx).

In some embodiments, BVx=BVPx+fx(stepIdx, dirIdx), and/or BVy=BVPy+fy(stepIdx, dirIdx), and where fx( ) and fy( ) denotes functions with stepIdx, dirIdx as input. In some other embodiments, BVx=BVPx+fx(BVPx, BVPy, stepIdx, dirIdx), and/or BVy=BVPy+fy(BVPx, BVPy, stepIdx, dirIdx), and where fx( ) and fy( ) denotes functions with BVPx, BVPy, stepIdx, dirIdx as input.

In some embodiments, the parameter related to the block vector difference comprises a difference vector that is derived from a step index and a direction index. In this case, the block vector may be represented as the base block vector candidate added with the difference vector. For example, the block vector is represented as (BVx, BVy), BVx is a first element of the block vector and BVy is a second element of the block vector, the base block vector candidate is represented as (BVPx, BVPy), BVPx is a first element of the base block vector candidate and BVPy is a second element of the base block vector candidate, and the difference vector is represented as (BVDx, BVDy), BVDx is a first element of the difference vector and BVDy is a second element of the difference vector. By way of example, the block vector (BVx, BVy) may be represented as a base candidate (BVPx, BVPy) added with a difference vector (BVDx, BVDy) that can be derived from a step index stepIdx and a direction index dirIdx.

In some embodiments, BVDx, is a function of the step index and the direction index. In some other embodiments, BVDy is a function of the step index and the direction index.

In some embodiments, if BVPx is equal to 0, BVDx is derived as 0. In some other embodiments, if BVPy is equal to 0, BVDy is derived as 0.

In some embodiments, a function to derive BVDy depends on whether BVPx is equal to 0 or not. In some other embodiments, a function to derive BVDx depends on whether BVPy is equal to 0 or not.

In some embodiments, a function to derive BVDy depends on whether BVPy is equal to 0 or not. In some other embodiments, a function to derive BVDx depends on whether BVPx is equal to 0 or not.

In some embodiments, a step difference of the block vector between two adjacent steps has a value that follows a limitation. For example, in some embodiments, the step difference between the two adjacent steps is fixed. In some embodiments, the step difference between the two adjacent steps is equal to k, and wherein k is an integer number. In some embodiments, k is equal to 1 or 2.

Alternatively, the step difference between the two adjacent steps is adaptive. In some embodiments, the step difference between the two adjacent steps is not larger than a predetermined number. In some embodiments, the predetermined number is one of: 4, 8, or 16.

In some embodiments, the step difference between the two adjacent steps is adaptive according to a step value. For example, the step difference between two adjacent steps is set to k1, if a larger step of the two adjacent steps is not larger than S1, and/or the step difference between two adjacent steps is set to k2, if the larger step is not larger than S2 and larger than S1, and/or the step difference between two adjacent steps is set to k3, if the larger step is larger than S2, and wherein k1, k2, k3, S1 and S2 are integer numbers. In some embodiments, k1=1, k2=2, k3=4, S1=64, S2=128.

In some embodiments, the BVDI or a part of the BVDI is binarized with EGk binarization. In some embodiments, the BVDI with one bit right shift is binarized with EGk binarization. In one example, BVDI>>1 may be binarized with EGk binarization. In some other embodiments, the BVDI with two bits right shift is binarized with EGk binarization. In one example, BVDI>>2 may be binarized with EGk binarization. In some embodiments, the BVDI with k bits right shift is binarized with EGk binarization, where k is a positive integer number. In one example, BVDI>>k (e.g., k is a positive integer) may be binarized with EGk binarization.

In some embodiments, the step index or a part of the step index may be binarized with a specific binarization. In some embodiments, the step index with one bit right shift is binarized with the specific binarization. In one example, stepIdx>>1 may be binarized with EGk binarization. In some embodiments, the step index with two bits right shift is binarized with the specific binarization. In one example, stepIdx>>2 may be binarized with EGk binarization. In some embodiments, the step index with k bits right shift is binarized with a specific binarization, wherein k is a positive integer number. In one example, stepIdx>>k (e.g., k is a positive integer) may be binarized with EGk binarization.

In some embodiments, last k bits of the BVDI is binarized with a fixed length binarization, where k is a positive integer number. In some embodiments, the last bit of the BVDI is binarized with the fixed length binarization. Alternatively, or in addition, the last 2 bits of the BVDI is binarized with the fixed length binarization.

In some embodiments, last k bits of the step index is binarized with a fixed length binarization, where k is a positive integer number. In some embodiments, the last bit of the step index is binarized with the fixed length binarization. Alternatively, or in addition, the last 2 bits of the step index is binarized with the fixed length binarization.

In some embodiments, an absolute value of BVDx minus a predefined number is binarized with a specific binarization process. Alternatively, or in addition an absolute value of BVDy minus the predefined number is binarized with the specific binarization process. For example, Abs(BVDx)−1 and/or Abs(BVDy)−1 may be binarized with a EGk (k>1) binarization process.

In some embodiments, the specific binarization process comprises one of: EG2 binarization process, EG3 binarization process, EG4 binarization process, or EG5 binarization process. In one example, Abs(BVDx)−1 may be binarized with EG2/EG3/EG4/EG5 binarization process. In one example, Abs(BVDy)−1 may be binarized with EG2/EG3/EG4/EG5 binarization process. In some embodiments, a binarized code is bypass coded.

In some embodiments, whether BVDx is equal to 0 is context coded. In one embodiment, the context depends on at least one of: BVPx or BVPy.

In some embodiments, whether BVDy is equal to 0 is context coded. In an example embodiment, the context depends on at least one of: BVPx or BVPy.

According to further embodiments of the present disclosure, a non-transitory computer-readable recording medium is provided. The non-transitory computer-readable recording medium stores a bitstream of a video which is generated by a method performed by an apparatus for video processing. The method comprises: determining a block vector of a video unit of the video based on a base block vector candidate and a parameter related to a block vector difference; and generating the bitstream based on the block vector.

According to still further embodiments of the present disclosure, a method for storing bitstream of a video is provided. The method comprises: determining a block vector of a video unit of the video based on a base block vector candidate and a parameter related to a block vector difference; generating the bitstream based on the block vector; and storing the bitstream in a non-transitory computer-readable recording medium.

Implementations of the present disclosure can be described in view of the following clauses, the features of which can be combined in any reasonable manner.

Clause 1. A method of video processing, comprising: determining, for a conversion between a video unit of a video and a bitstream of the video, a block vector of the video unit based on a base block vector candidate and a parameter related to a block vector difference; and performing the conversion based on the block vector.

Clause 2. The method of clause 1, wherein the parameter related to the block vector difference comprises a base vector difference index (BVDI), and wherein the block vector is represented based on the base block vector candidate and the BVDI.

Clause 3. The method of clause 2, wherein the block vector is represented as: (BVx, BVy)=f(BVPx, BVPy, BVDI), wherein BVx is a first element of the block vector and BVy is a second element of the block vector, the base block vector candidate is represented as (BVPx, BVPy), BVPx is a first element of the base block vector candidate and BVPy is a second element of the base block vector candidate, and f(represents a function of the base block vector candidate and the BVDI.

Clause 4. The method of any of clauses 1-3, wherein the base block vector candidate comprises one of: a merge candidate, a spatial block vector candidate, a history block vector candidate, a pair-wise block vector candidate, or a constant block vector candidate.

Clause 5. The method of clause 3, wherein BVx=BVPx+fx(BVDI), and/or BVy=BVPy+fy(BVDI), and wherein fx( ) and fy( ) denotes functions with BVDI as input.

Clause 6. The method of clause 3, wherein BVx=BVPx+fx(BVPx, BVPy, BVDI), and/or BVy=BVPy+fy(BVPx, BVPy, BVDI), and where fx( ) and fy( ) denotes functions with BVPx, BVPy, BVDI as input.

Clause 7. The method of clause 1, wherein the parameter related to the block vector difference comprises a difference vector that is derived from a BVDI, wherein the block vector is represented as the base block vector candidate added with the difference vector, and wherein the block vector is represented as (BVx, BVy), BVx is a first element of the block vector and BVy is a second element of the block vector, wherein the base block vector candidate is represented as (BVPx, BVPy), BVPx is a first element of the base block vector candidate and BVPy is a second element of the base block vector candidate, and wherein the difference vector is represented as (BVDx, BVDy), BVDx is the first element of the difference vector and BVDy is the second element of the difference vector.

Clause 8. The method of clause 7, wherein BVDx is a function of the BVDI.

Clause 9. The method of clause 7, wherein BVDy is a function of the BVDI.

Clause 10. The method of clause 7, wherein if BVPx is equal to 0, BVDx is derived as 0.

Clause 11. The method of clause 7, wherein if BVPy is equal to 0, BVDy is derived as 0.

Clause 12. The method of clause 7, wherein a function to derive BVDy depends on whether BVPx is equal to 0 or not.

Clause 13. The method of clause 7, wherein a function to derive BVDx depends on whether BVPy is equal to 0 or not.

Clause 14. The method of clause 7, wherein a function to derive BVDy depends on whether BVPy is equal to 0 or not.

Clause 15. The method of clause 7, wherein a function to derive BVDx depends on whether BVPx is equal to 0 or not.

Clause 16. The method of any of clauses 1-15, wherein the BVDI comprises at least one of: a maximum value or a minimum value.

Clause 17. The method of clause 1, wherein the parameter related to the block vector difference comprises a step index and a direction index, and wherein the block vector is represented based on the base block vector candidate, the step index and the direction index.

Clause 18. The method of clause 17, wherein (BVx, BVy)=f(BVPx, BVPy, stepIdx, dirIdx), and wherein (BVx, BVy) represents the block vector, (BVPx, BVPy) represents the base block vector candidate, f( ) represents the function of the base block vector candidate, the step index and the direction indes, stepIdx represents the step index, and dirIdx represents the direction index.

Clause 19. The method of clause 17, wherein BVx=BVPx+fx(stepIdx, dirIdx), and/or BVy=BVPy+fy(stepIdx, dirIdx), and wherein fx( ) and fy( ) denotes functions with stepIdx, dirIdx as input.

Clause 20. The method of clause 17, wherein BVx=BVPx+fx(BVPx, BVPy, stepIdx, dirIdx), and/or BVy=BVPy+fy(BVPx, BVPy, stepIdx, dirIdx), and wherein fx( ) and fy( ) denotes functions with BVPx, BVPy, stepIdx, dirIdx as input.

Clause 21. The method of clause 1, wherein the parameter related to the block vector difference comprises a difference vector that is derived from a step index and a direction index, wherein the block vector is represented as the base block vector candidate added with the difference vector, and wherein the block vector is represented as (BVx, BVy), BVx is a first element of the block vector and BVy is a second element of the block vector, wherein the base block vector candidate is represented as (BVPx, BVPy), BVPx is a first element of the base block vector candidate and BVPy is a second element of the base block vector candidate, and wherein the difference vector is represented as (BVDx, BVDy), BVDx is a first element of the difference vector and BVDy is a second element of the difference vector.

Clause 22. The method of clause 21, wherein BVDx, is a function of the step index and the direction index.

Clause 23. The method of clause 21, wherein BVDy is a function of the step index and the direction index.

Clause 24. The method of clause 21, wherein if BVPx is equal to 0, BVDx is derived as 0.

Clause 25. The method of clause 21, wherein if BVPy is equal to 0, BVDy is derived as 0.

Clause 26. The method of clause 21, wherein a function to derive BVDy depends on whether BVPx is equal to 0 or not.

Clause 27. The method of clause 21, wherein a function to derive BVDx depends on whether BVPy is equal to 0 or not.

Clause 28. The method of clause 21, wherein a function to derive BVDy depends on whether BVPy is equal to 0 or not.

Clause 29. The method of clause 21, wherein a function to derive BVDx depends on whether BVPx is equal to 0 or not.

Clause 30. The method of any of clauses 1-29, wherein a step difference of the block vector between two adjacent steps has a value that follows a limitation.

Clause 31. The method of clause 30, wherein the step difference between the two adjacent steps is fixed.

Clause 32. The method of clause 31, wherein the step difference between the two adjacent steps is equal to k, and wherein k is an integer number.

Clause 33. The method of clause 32, wherein k is equal to 1 or 2.

Clause 34. The method of clause 30, wherein the step difference between the two adjacent steps is adaptive.

Clause 35. The method of clause 30, wherein the step difference between the two adjacent steps is not larger than a predetermined number.

Clause 36. The method of clause 35, wherein the predetermined number is one of: 4, 8, or 16.

Clause 37. The method of clause 30, wherein the step difference between the two adjacent steps is adaptive according to a step value.

Clause 38. The method of clause 37, wherein the step difference between two adjacent steps is set to k1, if a larger step of the two adjacent steps is not larger than S1, and/or the step difference between two adjacent steps is set to k2, if the larger step is not larger than S2 and larger than S1, and/or the step difference between two adjacent steps is set to k3, if the larger step is larger than S2, and wherein k1, k2, k3, S1 and S2 are integer numbers.

Clause 39. The method of clause 38, wherein k1=1, k2=2, k3=4, S1=64, S2=128.

Clause 40. The method of any of clauses 1-39, wherein the BVDI or a part of the BVDI is binarized with EGk binarization.

Clause 41. The method of clause 40, wherein the BVDI with one bit right shift is binarized with EGk binarization.

Clause 42. The method of clause 40, wherein the BVDI with two bits right shift is binarized with EGk binarization.

Clause 43. The method of clause 40, wherein the BVDI with k bits right shift is binarized with EGk binarization, wherein k is a positive integer number.

Clause 44. The method of any of clauses 1-39, wherein the step index or a part of the step index is binarized with a specific binarization.

Clause 45. The method of clause 44, wherein the step index with one bit right shift is binarized with the specific binarization.

Clause 46. The method of clause 44, wherein the step index with two bits right shift is binarized with the specific binarization.

Clause 47. The method of clause 44, wherein the step index with k bits right shift is binarized with a specific binarization, wherein k is a positive integer number.

Clause 48. The method of clause any of clauses 1-39, wherein last k bits of the BVDI is binarized with a fixed length binarization, wherein k is a positive integer number.

Clause 49. The method of clause 48, wherein the last bit of the BVDI is binarized with the fixed length binarization, or wherein the last 2 bits of the BVDI is binarized with the fixed length binarization.

Clause 50. The method of any of clauses 1-39, wherein last k bits of the step index is binarized with a fixed length binarization, wherein k is a positive integer number.

Clause 51. The method of clause 50, wherein the last bit of the step index is binarized with the fixed length binarization, or wherein the last 2 bits of the step index is binarized with the fixed length binarization.

Clause 52. The method of any of clauses 1-39, wherein an absolute value of BVDx minus a predefined number is binarized with a specific binarization process, and/or wherein an absolute value of BVDy minus the predefined number is binarized with the specific binarization process.

Clause 53. The method of clause 52, wherein the specific binarization process comprises one of: EG2 binarization process, EG3 binarization process, EG4 binarization process, or EG5 binarization process.

Clause 54. The method of clause 53, wherein a binarized code is bypass coded.

Clause 55. The method of clause 52, wherein whether BVDx is equal to 0 is context coded.

Clause 56. The method of clause 55, wherein the context depends on at least one of: BVPx or BVPy.

Clause 57. The method of clause 52, wherein whether BVDy is equal to 0 is context coded.

Clause 58. The method of clause 57, wherein the context depends on at least one of: BVPx or BVPy.

Clause 59. The method of any of clauses 1-58, wherein the conversion includes encoding the video unit into the bitstream.

Clause 60. The method of any of clauses 1-58, wherein the conversion includes decoding the video unit from the bitstream.

Clause 61. An apparatus for video processing comprising a processor and a non-transitory memory with instructions thereon, wherein the instructions upon execution by the processor, cause the processor to perform a method in accordance with any of clauses 1-60.

Clause 62. A non-transitory computer-readable storage medium storing instructions that cause a processor to perform a method in accordance with any of clauses 1-60.

Clause 63. A non-transitory computer-readable recording medium storing a bitstream of a video which is generated by a method performed by an apparatus for video processing, wherein the method comprises: determining a block vector of a video unit of the video based on a base block vector candidate and a parameter related to a block vector difference; and generating the bitstream based on the block vector.

Clause 64. A method for storing a bitstream of a video, comprising: determining a block vector of a video unit of the video based on a base block vector candidate and a parameter related to a block vector difference; generating the bitstream based on the block vector; and storing the bitstream in a non-transitory computer-readable recording medium.

### Example Device

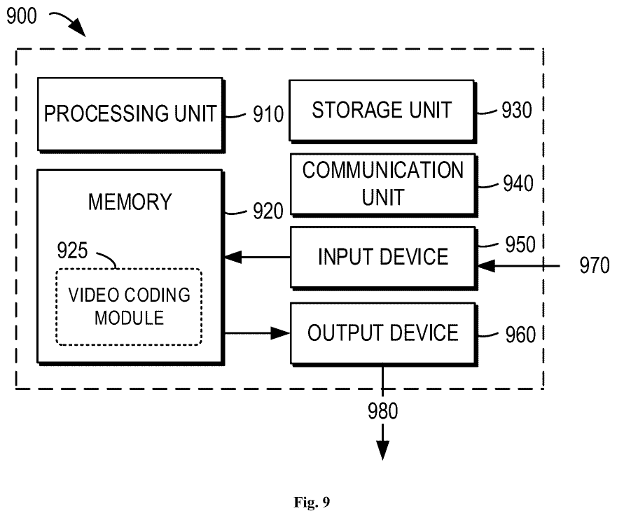

FIG. 9 illustrates a block diagram of a computing device 900 in which various embodiments of the present disclosure can be implemented. The computing device 900 may be implemented as or included in the source device 110 (or the video encoder 114 or 200) or the destination device 120 (or the video decoder 124 or 300).

It would be appreciated that the computing device 900 shown in FIG. 9 is merely for purpose of illustration, without suggesting any limitation to the functions and scopes of the embodiments of the present disclosure in any manner.

As shown in FIG. 9, the computing device 900 includes a general-purpose computing device 900. The computing device 900 may at least comprise one or more processors or processing units 910, a memory 920, a storage unit 930, one or more communication units 940, one or more input devices 950, and one or more output devices 960.

In some embodiments, the computing device 900 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 900 can support any type of interface to a user (such as “wearable” circuitry and the like).

The processing unit 910 may be a physical or virtual processor and can implement various processes based on programs stored in the memory 920. In a multi-processor system, multiple processing units execute computer executable instructions in parallel so as to improve the parallel processing capability of the computing device 900. The processing unit 910 may also be referred to as a central processing unit (CPU), a microprocessor, a controller or a microcontroller.

The computing device 900 typically includes various computer storage medium. Such medium can be any medium accessible by the computing device 900, including, but not limited to, volatile and non-volatile medium, or detachable and non-detachable medium. The memory 920 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 930 may be any detachable or non-detachable medium and may include a machine-readable medium such as a memory, flash memory drive, magnetic disk or another other media, which can be used for storing information and/or data and can be accessed in the computing device 900.

The computing device 900 may further include additional detachable/non-detachable, volatile/non-volatile memory medium. Although not shown in FIG. 9, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 940 communicates with a further computing device via the communication medium. In addition, the functions of the components in the computing device 900 can be implemented by a single computing cluster or multiple computing machines that can communicate via communication connections. Therefore, the computing device 900 can operate in a networked environment using a logical connection with one or more other servers, networked personal computers (PCs) or further general network nodes.

The input device 950 may be one or more of a variety of input devices, such as a mouse, keyboard, tracking ball, voice-input device, and the like. The output device 960 may be one or more of a variety of output devices, such as a display, loudspeaker, printer, and the like. By means of the communication unit 940, the computing device 900 can further communicate with one or more external devices (not shown) such as the storage devices and display device, with one or more devices enabling the user to interact with the computing device 900, or any devices (such as a network card, a modem and the like) enabling the computing device 900 to communicate with one or more other computing devices, if required. Such communication can be performed via input/output (I/O) interfaces (not shown).

In some embodiments, instead of being integrated in a single device, some or all components of the computing device 900 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 900 may be used to implement video encoding/decoding in embodiments of the present disclosure. The memory 920 may include one or more video coding modules 925 having one or more program instructions. These modules are accessible and executable by the processing unit 910 to perform the functionalities of the various embodiments described herein.

In the example embodiments of performing video encoding, the input device 950 may receive video data as an input 970 to be encoded. The video data may be processed, for example, by the video coding module 925, to generate an encoded bitstream. The encoded bitstream may be provided via the output device 960 as an output 980.

In the example embodiments of performing video decoding, the input device 950 may receive an encoded bitstream as the input 970. The encoded bitstream may be processed, for example, by the video coding module 925, to generate decoded video data. The decoded video data may be provided via the output device 960 as the output 980.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method of video processing, comprising:
determining, for a conversion between a video unit of a video and a bitstream of the video, a block vector of the video unit based on a base block vector candidate and a parameter related to a block vector difference; and
performing the conversion based on the block vector.

2. The method of claim 1, wherein the parameter related to the block vector difference comprises a base vector difference index (BVDI), and
wherein the block vector is represented based on the base block vector candidate and the BVDI.

3. The method of claim 2, wherein the block vector is represented as:
(BVx,BVy)=f(BVPx,BVPy,BVDI),
wherein BVx is a first element of the block vector and BVy is a second element of the block vector, the base block vector candidate is represented as (BVPx, BVPy), BVPx is a first element of the base block vector candidate and BVPy is a second element of the base block vector candidate, and f( ) represents a function of the base block vector candidate and the BVDI.

4. The method of claim 3, wherein BVx=BVPx+fx(BVDI), and/or BVy=BVPy+fy(BVDI), and wherein fx( ) and fy( ) denotes functions with BVDI as input, or wherein BVx=BVPx+fx(BVPx, BVPy, BVDI), and/or BVy=BVPy+fy(BVPx, BVPy, BVDI), and wherein fx( ) and fy( ) denotes functions with BVPx, BVPy, BVDI as input.

5. The method of claim 1, wherein the base block vector candidate comprises one of:
a merge candidate,
a spatial block vector candidate,
a history block vector candidate,
a pair-wise block vector candidate, or
a constant block vector candidate.

6. The method of claim 1, wherein the parameter related to the block vector difference comprises a difference vector that is derived from a BVDI,
wherein the block vector is represented as the base block vector candidate added with the difference vector, and
wherein the block vector is represented as (BVx, BVy), BVx is a first element of the block vector and BVy is a second element of the block vector,
wherein the base block vector candidate is represented as (BVPx, BVPy), BVPx is a first element of the base block vector candidate and BVPy is a second element of the base block vector candidate, and
wherein the difference vector is represented as (BVDx, BVDy), BVDx is the first element of the difference vector and BVDy is the second element of the difference vector.

7. The method of claim 6, wherein BVDx is a function of the BVDI, or
wherein BVDy is a function of the BVDI, or
wherein if BVPx is equal to 0, BVDx is derived as 0, or
wherein if BVPy is equal to 0, BVDy is derived as 0, or
wherein a function to derive BVDy depends on whether BVPx is equal to 0 or not, or
wherein a function to derive BVDx depends on whether BVPy is equal to 0 or not, or
wherein a function to derive BVDy depends on whether BVPy is equal to 0 or not, or
wherein a function to derive BVDx depends on whether BVPx is equal to 0 or not.

8. The method of claim 1, wherein the BVDI comprises at least one of: a maximum value or a minimum value.

9. The method of claim 1, wherein a step difference of the block vector between two adjacent steps has a value that follows a limitation.

10. The method of claim 9, wherein the step difference between the two adjacent steps is fixed.

11. The method of claim 10, wherein the step difference between the two adjacent steps is equal to k, and wherein k is an integer number.

12. The method of claim 11, wherein k is equal to 1 or 2.

13. The method of claim 9, wherein the step difference between the two adjacent steps is adaptive, or
wherein the step difference between the two adjacent steps is not larger than a predetermined number, or
wherein the step difference between the two adjacent steps is adaptive according to a step value.

14. The method of claim 13, wherein the predetermined number is one of: 4, 8, or 16.

15. The method of claim 13, wherein the step difference between two adjacent steps is set to k1, if a larger step of the two adjacent steps is not larger than S1, and/or
the step difference between two adjacent steps is set to k2, if the larger step is not larger than S2 and larger than S1, and/or
the step difference between two adjacent steps is set to k3, if the larger step is larger than S2,
and wherein k1, k2, k3, S1 and S2 are integer numbers.

16. The method of claim 15, wherein k1=1, k2=2, k3=4, S1=64, S2=128.

17. The method of claim 1, wherein the conversion includes encoding the video unit into the bitstream, or
wherein the conversion includes decoding the video unit from the bitstream.

18. An apparatus for video processing comprising a processor and a non-transitory memory with instructions thereon, wherein the instructions upon execution by the processor, cause the processor to:
determine, for a conversion between a video unit of a video and a bitstream of the video, a block vector of the video unit based on a base block vector candidate and a parameter related to a block vector difference; and
perform the conversion based on the block vector.

19. A non-transitory computer-readable storage medium storing instructions that cause a processor to:
determine, for a conversion between a video unit of a video and a bitstream of the video, a block vector of the video unit based on a base block vector candidate and a parameter related to a block vector difference; and
perform the conversion based on the block vector.

20. A non-transitory computer-readable recording medium storing a bitstream of a video which is generated by a method performed by an apparatus for video processing, wherein the method comprises:
determining a block vector of a video unit of the video based on a base block vector candidate and a parameter related to a block vector difference; and
generating the bitstream based on the block vector.
